(19) United States
(12) Patent Application Publication
(10) Pub. No.: US 2014/0044767 A1
(43) Pub. Date: Feb. 13, 2014

(54) COMPOSITION AND METHOD OF USE FOR A COCKROACH KILLING INSECTICIDE

(71) Applicants: DEBRA PENNINGTON, Fort Worth, TX (US); Riana Rowe, Fort Worth, TX (US)

(72) Inventors: DEBRA PENNINGTON, Fort Worth, TX (US); Riana Rowe, Fort Worth, TX (US)

(21) Appl. No.: 13/584,788

(22) Filed: Aug. 13, 2012

(51) Int. Cl. A01N 59/14

(52) U.S. Cl. CPC A01N 59/14
USPC 424/410; 424/659

(57) ABSTRACT

A chemical composition to kill a plurality of cockroaches comprising: boric acid, where the boric acid is utilized to kill the cockroaches; flour, where the flour serves as a binding agent; sugar, where the sugar baits and attracts the cockroaches; and water, where the water combines the boric acid, the flour, and the sugar to create a mixture and then the mixture is placed in a specific location where cockroaches are anticipated to be. The sugars used may be powered sugar or brown sugar to attract the cockroaches.

### CROSS REFERENCE TO OTHER APPLICATIONS

This application claims priority to U.S. Provisional Application Ser. No. ______ filed on Aug. 13, 2011

### BACKGROUND OF THE INVENTION

1. Field of the Invention

The present invention relates to a pest killing insecticide specifically targeted to killing cockroaches.

2. Description of Related Art

Pests like ants, cockroaches, spiders and many other creepy crawlers are common problems within living dwellings and social environments, ultimately serving as a constant nuisance. In addition to being bothersome, the pests create safety and health hazards to those inhabiting the dwelling. In attempts to kill the pests, insecticides and traps are used. The traps may be set in areas where the pests are anticipated to roam. The insecticides are typically used when the individual sees the pests and then chases them down to spray them or their trail. Many insecticides are harmful and dangerous to the individuals living or occupying the building which adds an additional stress besides just having the bugs in the building.

It would be beneficial in the art to provide an insecticide that is homemade to allow the user to know exactly what is in it while still being an effective pest killing solution. It would also be desirable in the art to provide an insecticide that may be formed and placed strategically as desired by the user.

### SUMMARY OF THE INVENTION

In view of the foregoing disadvantages inherent in the prior art, the general purpose of the present invention is to provide an insecticide for cockroaches, configured to include all of the advantages of the prior art, and to overcome the drawbacks inherent therein.

Accordingly, an object of the present invention is to provide an insecticide for chemically killing cockroaches that is easy to apply and utilize.

Another object of the present invention is to provide an insecticide for chemically killing cockroaches that may be utilized in an open and vacant area.

To achieve the above objects, in an aspect of the present invention, a chemical composition to kill cockroaches is described comprising: boric acid, where the boric acid is utilized to kill the cockroaches; flour, where the flour serves as a binding agent; sugar, where the sugar baits and attracts the cockroaches; and water, where the water combines the boric acid, the flour, and the sugar to create a mixture and then placed in a specific location where cockroaches are anticipated to be. The sugars used may be powered sugar or brown sugar to attract the cockroaches.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a flowchart of a method for using an insecticide for chemically killing cockroaches in accordance with an exemplary embodiment of the present invention.

### DETAILED DESCRIPTION OF THE DRAWINGS

The present invention relates to a pest killing insecticide specifically targeted to killing cockroaches. The insecticide includes two different chemical compositions. The first chemical composition utilizes powdered sugar and is for killing cockroaches in an ordinary environment. The second chemical composition utilizes brown sugar and is for killing cockroaches in an open area such as a vacant apartment.

The first chemical composition includes boric acid, flour, powdered sugar, and water. The boric acid is utilized to kill the cockroaches that come in contact with the first chemical composition. The boric acid does not kill the cockroaches immediately, but does so based on a predetermined period of time after being ingested. The flour may be any type or brand grain based flour, serving as a binding agent for the boric acid and the powdered sugar. The powdered sugar baits and attracts the cockroaches, and may be any type of branded powdered sugar. A relatively small amount of water is added to the boric acid, flour and powdered sugar mixture, enough to form a dough-like consistency of the first chemical composition. A suitable quantity, percentage by weight or percentage by volume of boric acid, flour, powdered sugar and water may be utilized to manufacture the first composition into dough to create the balls.

The first chemical composition is formed into a plurality of balls, which may range in size from peas to large grapes or approximately 1-3 centimeters in diameter. Preferably the ball is the size of a marble, or 1.3 centimeters. The balls are strategically placed throughout a specific location where it is anticipated that the cockroaches will go. A pair of gloves is typically worn by a user to handle and place the balls. Once in place, the cockroaches approach and partially consume the balls. After contact with the balls, the first chemical composition is brought back to the cockroach nest or other commonly inhabited cockroach community via the cockroaches that initial came into contact with the balls. The first chemical composition then comes into contact with other cockroaches in the nest to eventually kill all of them as well as the cockroaches that initially came into contact with the balls.

The second chemical composition includes boric acid, flour, brown sugar, and water. The second chemical composition is similar to the first chemical composition except that the powdered sugar is substituted with brown sugar. The brown sugar may be powdered or granulated brown sugar. Similar to the first chemical composition, the boric acid does not kill the cockroaches immediately, but does so after a time period after being ingested. This allows the cockroaches to transport the second chemical composition back to their nests.

When the boric acid, flour, and brown sugar are combined with water the mixture may then be formed into a plurality of lines that are positioned around the perimeter of a large open area. Once contact has been made with the second chemical composition, the cockroaches bring it back to their nest to eventually kill the first cockroaches and their community members.

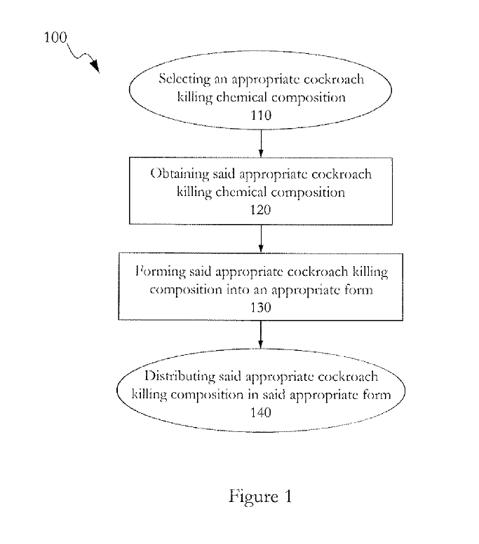

Turning now descriptively to the drawings, referring to FIG. 1, a flowchart of a method 100 for using the insecticide for chemically killing cockroaches in accordance with an exemplary embodiment of the present invention. The steps of the overall method 100 include selecting an appropriate cockroach killing chemical composition 110, obtaining the appropriate cockroach killing chemical composition 120, forming the appropriate cockroach killing composition into an appropriate form 130 and distributing the appropriate cockroach killing composition in the appropriate form 140.

In selecting step 110, the user may choose between a first chemical composition and a second chemical composition. The first chemical composition is utilized for normal environments, such as a furnished apartment. The second chemical composition is utilized for open or vacant environments, such as a vacant apartment or other vacant open areas. In obtaining step 120, the user straightforwardly obtains the appropriate chemical composition from any suitable chemical composition source such as hardware store, although other suitable sources may be utilized. In the forming of step 130, the first chemical composition is combined with a relatively small amount of water to form a paste or dough-like substance which is then formed into marble sized balls. Alternatively, with the second chemical composition the substance is formed into a plurality of lines. In distributing step 140 the marble sized balls are strategically placed throughout a specific location where it is anticipated that the cockroaches might go. The second chemical composition is typically for utilization in an open or vacant area and is typically combined with water to form a plurality of lines and positioned around the perimeter of the open or vacant area, although the second chemical composition may be utilized in any suitable location and orientation.

The chemical compositions offer an alternative approach to pest control. Comprised of boric acid and flour to create a poisonous binding substance, the chemical composition incorporates a sugar component, specifically powdered sugar for regular application or brown sugar for vacant building application. The sugar component is added specifically to entice the cockroaches or other insects and vermin. With the addition of water, the chemical composition may be made into marble sized balls placed strategically throughout an occupied dwelling or utilized as a pour lining defense within a vacant building. The chemical composition may be used discreetly in households and commercial areas infested with cockroaches and other insects.

The chemical compositions are applied with controlled application options and a pair of prepackaged plastic gloves to provide a completed cockroach eliminating kit. The chemical compositions are poisonous mixtures, which cockroaches will not become immune to and require minimal set-up. The chemical composition affords the users with a relatively simplified method of utilizing insecticides.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A chemical composition to kill a plurality of cockroaches comprising:
a. boric acid, where the boric acid is utilized to kill the cockroaches;
b. flour, where the flour serves as a binding agent;
c. sugar, where the sugar baits and attracts the cockroaches; and
d. water, where the water combines the boric acid, the flour, and the sugar to create a mixture and then the mixture is placed in a specific location where cockroaches are anticipated to be.

2. The chemical composition according to claim 1, wherein the sugar is powdered sugar.

3. The chemical composition according to claim 1, wherein the sugar is brown sugar.

4. The chemical composition according to claim 1, wherein the boric acid kills the cockroaches based on a predetermined period of time after being ingested.

5. The chemical composition according to claim 1, wherein the mixture is formed into a dough-like substance.

6. The chemical composition according to claim 5, wherein the dough-like substance is formed into a plurality of balls.

7. The chemical composition according to claim 6, wherein the plurality of balls are 1.3 centimeters in diameter.

8. The chemical composition according to claim 5, wherein the dough-like substance is formed into lines.

9. A method for using a cockroach killing insecticide comprising the steps of:
a. selecting a chemical composition, where the chemical composition is chosen between a first chemical composition and a second chemical composition depending on a specified location; and
b. distributing the cockroach killing chemical composition in the specified location.

10. The method of using a cockroach killing insecticide according to claim 9, after selecting the first chemical composition, further including the steps of:
a. adding water to the first chemical composition to create a mixture, where the mixture comprises a dough-like consistency;
b. forming the mixture into a plurality of balls; and
c. distributing the balls within various areas of the specified location.

11. The method of using a cockroach killing insecticide according to claim 9, after selecting the second chemical composition, further including the steps of:
a. adding water to the second chemical composition to create a mixture;
b. forming the mixture into a plurality of lines; and
c. placing the lines around a perimeter of the specified location.

12. The method of using a cockroach killing insecticide according to claim 9 further including the step of wearing gloves to distribute the chemical composition.
